(19) United States
(12) Patent Application Publication
(10) Pub. No.: US 2005/0232355 A1
(43) Pub. Date: Oct. 20, 2005

(54) Video decoder for supporting both single and four motion vector macroblocks

(76) Inventors: Srinivas Cheedela, Bangalore (IN); Ramadas Lakshmikanth Pai, Bangalore (IN); Chhavi Kishore, Bangalore (IN)

Correspondence Address: MCANDREWS HELD & MALLOY, LTD, 500 WEST MADISON STREET, SUITE 3400, CHICAGO, IL, 60661, US

(21) Appl. No.: 10/824,897

(22) Filed: Apr. 15, 2004

(51) Int. Cl. H04N 7/12

(52) U.S. Cl. 375/240.16; 375/240.24; 375/240.25

(57) ABSTRACT

Presented herein is a video decoder for supporting both single and four motion vector macroblocks. In one embodiment, the video decoder comprises a processor, a motion vector address computer, a video request manager, and a pixel reconstructor. The processor decodes a set of parameters. The set of parameters comprises motion vectors indicating reference pixels associated with the macroblock. The motion vector address computer calculates addresses associated with motion vectors. The video request manager fetches a block of reference pixels at the addresses calculated by the motion vector address computer. The pixel reconstructor reconstructs pixels from the macroblocks. The pixel reconstructor is operable to reconstruct pixels from macroblocks encoded in accordance with a plurality of standards.

### RELATED APPLICATIONS

[Not Applicable]

### FEDERALLY SPONSORED RESEARCH OR DEVELOPMENT

[Not Applicable]

[MICROFICHE/COPYRIGHT REFERENCE]

[Not Applicable]

### BACKGROUND OF THE INVENTION

Common video compression algorithms use compression based on temporal redundancies between pictures in the video. For example, MPEG-2 defines pictures that can be predicted from one other picture (a P-picture), two pictures (a B-picture), or not predicted from another picture at all (an I-picture).

Portions, known as macroblocks, from B and P pictures are predicted from reference pixels in a reference picture. The reference pixels can be spatially displaced from the macroblock that is predicted therefrom. Accordingly, the macroblock is encoded, along with indicator(s) indicating the spatial displacements of the reference pixels from the position of the macroblock. The indicator(s) is known as a motion vector.

During decoding, the motion vectors are used to retrieve the reference pixels. The reference pixels are retrieved from a memory storing the reference frame. The memory storing the reference frame is known as a frame buffer. A motion vector address computer determines the appropriate addresses storing the reference pixels for a macroblock, based on motion vectors.

Each macroblock includes four luma blocks as well as chroma blocks. In MPEG-2, each of the luma blocks in the macroblock that are horizontally adjacent are associated with the same motion vectors. However, in MPEG4 Part2, there are modes of operation where each of the luma blocks in a macroblock can be associated with their own set of motion vectors.

Preexisting hardware designed for MPEG-2 decoding may not be suitable for decoding AVC. For example, video decoder may include a pixel reconstructor. The pixel reconstructor may decode multiple luma blocks together, because each luma block is associated with the same set of motion vector. However, the foregoing pixel reconstructor may not be suitable for decoding AVC, where the luma blocks of a macroblock may be associated with different sets of motion vectors.

Further limitations and disadvantages of conventional and traditional approaches will become apparent to one of ordinary skill in the art through comparison of such systems with the present invention as set forth in the remainder of the present application with reference to the drawings.

### BRIEF SUMMARY OF THE INVENTION

Presented herein is a video decoder for supporting both single and four motion vector macroblocks.

In one embodiment, there is presented a video decoder for decoding macroblocks. The video decoder comprises a processor, a motion vector address computer, a video request manager, and a pixel reconstructor. The processor decodes a set of parameters. The set of parameters comprises motion vectors indicating reference pixels associated with the macroblock. The motion vector address computer calculates addresses associated with motion vectors. The video request manager fetches a block of reference pixels at the addresses calculated by the motion vector address computer. The pixel reconstructor reconstructs pixels from the macroblocks. The pixel reconstructor is operable to reconstruct pixels from macroblocks encoded in accordance with a plurality of standards.

In another embodiment, there is presented a pixel reconstructor for decoding macroblocks. The pixel reconstructor comprises a macroblock input buffer, a multiplexer, a horizontal register, and a horizontal data path. The multiplexer is connected to the macroblock input buffer. The horizontal register is connected to the multiplexer. The horizontal data path is connected in parallel to the horizontal register.

These and other features and advantages of the present invention may be appreciated from a review of the following detailed description of the present invention, along with the accompanying figures in which like reference numerals refer to like parts throughout.

### BRIEF DESCRIPTION OF SEVERAL VIEWS OF THE DRAWINGS

FIG. 1a is a block diagram of an exemplary Moving Picture Experts Group (MPEG) encoding process.

FIG. 1b is a block diagram of exemplary pictures.

FIG. 1c is a block diagram describing the exemplary pictures in decoding order.

FIG. 2 is a block diagram of an exemplary decoder system in accordance with an embodiment of the present invention;

FIG. 3 is a block diagram of an exemplary video decoder in accordance with an embodiment of the present invention;

FIG. 4 is a block diagram describing the data flow of a pixel reconstructor for MPEG-2 encoded video data in accordance with an embodiment of the present invention; and

FIG. 5 is a block diagram describing the data flow of a pixel reconstructor for AVC encoded video data in accordance with an embodiment of the present invention.

### DETAILED DESCRIPTION OF THE INVENTION

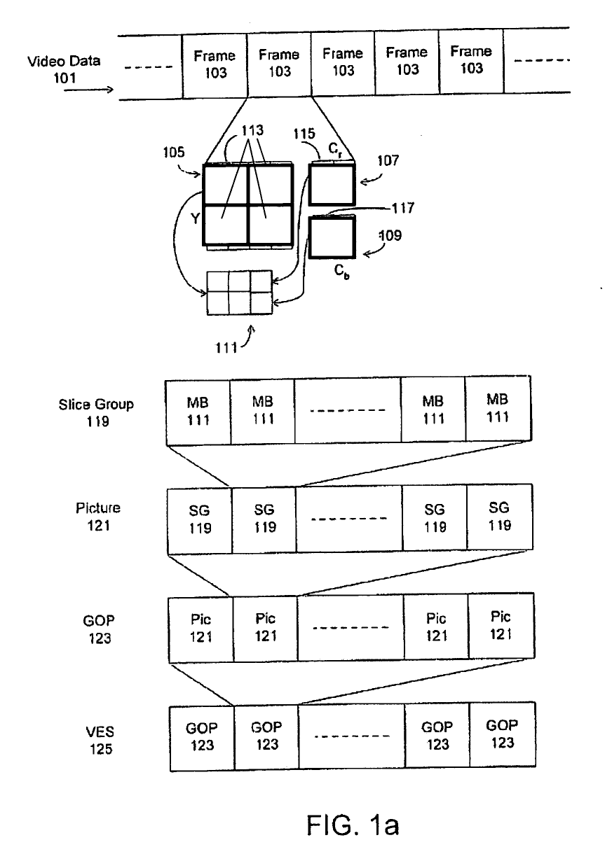

FIG. 1a illustrates a block diagram of an exemplary Moving Picture Experts Group (MPEG) encoding process of video data 101, in accordance with an embodiment of the present invention. The video data 101 comprises a series of frames 103. Each frame 103 comprises two-dimensional grids of luminance Y, 105, chrominance red Cr, 107, and chrominance blue Cb, 109, pixels. The two-dimensional grids are divided into 8×8 blocks 113, where a group of four blocks or a 16×16 block of luminance pixels Y is associated with a block 115 of chrominance red Cr, and a block 117 of chrominance blue Cb pixels. The blocks 113 of luminance pixels Y, along with its corresponding block 115 of chrominance red pixels Cr, and block 117 of chrominance blue pixels Cb form a data structure known as a macroblock 111. The macroblock 111 also includes additional parameters, including motion vectors, explained hereinafter. Each macroblock 111 represents image data in a 16×16 block area of the image.

The data in the macroblocks 111 is compressed in accordance with algorithms that take advantage of temporal and spatial redundancies. For example, in a motion picture, neighboring frames 103 usually have many similarities. Motion causes an increase in the differences between frames, the difference being between corresponding pixels of the frames, which necessitate utilizing large values for the transformation from one frame to another. The differences between the frames may be reduced using motion compensation, such that the transformation from frame to frame is minimized. The idea of motion compensation is based on the fact that when an object moves across a screen, the object may appear in different positions in different frames, but the object itself does not change substantially in appearance, in the sense that the pixels comprising the object have very close values, if not the same, regardless of their position within the frame. Measuring and recording the motion as a vector can reduce the picture differences. The vector can be used during decoding to shift a macroblock 111 of one frame to the appropriate part of another frame, thus creating movement of the object. Hence, instead of encoding the new value for each pixel, a block of pixels can be grouped, and the motion vector, which determines the position of that block of pixels in another frame, is encoded.

Accordingly, many of the macroblocks 111 are compared to pixels of other frames 103 (reference frames). When an appropriate (most similar, i.e. containing the same object(s)) portion of a reference frame 103 is found, the differences between the portion of the reference frame 103 (reference pixels) and the macroblock 111 are encoded. The difference between the portion of the reference frame 103 and the macroblock 111, the prediction error, is encoded using the discrete cosine transformation, thereby resulting in frequency coefficients. The frequency coefficients are then quantized and Huffman coded.

The location of the reference pixels in the reference frame 103 is recorded as a motion vector. The motion vector describes the spatial displacement between the macroblock 111 and the reference pixels. The encoded prediction error and the motion vector form part of the data structure encoding the macroblock 111. In the MPEG-2 standard, the macroblocks 111 from one frame 103 (a predicted frame) are limited to prediction from reference pixels of no more than two reference frames 103. It is noted that frames 103 used as a reference frame for a predicted frame 103 can be a predicted frame 103 from another reference frame 103.

In MPEG-2, each of the luma blocks in the macroblock that are horizontally adjacent are associated with the same motion vectors. However, in Advanced Video Coding (AVC), there are modes of operation where each of the luma blocks 113 in a macroblock 111 can be associated with their own set of motion vectors.

I₀, B₁, B₂, P₃, B₄, B₅, and P₆, FIG. 1b, are exemplary pictures. The arrows illustrate the temporal prediction dependence of each picture. For example, picture B₂ is dependent on reference pictures I₀, and P₃. Pictures coded using temporal redundancy with respect to exclusively earlier pictures of the video sequence are known as predicted pictures (or P-pictures), for example picture P₃ is coded using reference picture I₀. Pictures coded using temporal redundancy with respect to earlier and/or later pictures of the video sequence are known as bi-directional pictures (or B-pictures), for example, pictures B₁ is coded using pictures I₀ and P₃. Pictures not coded using temporal redundancy are known as I-pictures, for example I₀. In the MPEG-2 standard, I-pictures and P-pictures are also referred to as reference pictures.

The foregoing data dependency among the pictures requires decoding of certain pictures prior to others. Additionally, the use of later pictures as reference pictures for previous pictures requires that the later picture be decoded prior to the previous picture. As a result, the pictures may be decoded in a different order than the order in which they will be displayed on the screen. Accordingly, the pictures are transmitted in data dependent order, and the decoder reorders the pictures for presentation after decoding. I₀, P₃, B₁, B₂, P₆, B₄, B₅, FIG. 1c, represent the pictures in data dependent and decoding order, different from the display order seen in FIG. 1b.

The macroblocks 111 representing a frame are grouped into different slice groups 119. The slice group 119 includes the macroblocks 111, as well as additional parameters describing the slice group. Each of the slice groups 119 forming the frame form the data portion of a picture structure 121. The picture 121 includes the slice groups 119 as well as additional parameters that further define the picture 121.

The pictures are then grouped together as a group of pictures (GOP) 123. The GOP 123 also includes additional parameters further describing the GOP. Groups of pictures 123 are then stored, forming what is known as a video elementary stream (VES) 125. The VES 125 is then packetized to form a packetized elementary sequence. Each packet is then associated with a transport header, forming what are known as transport packets.

The transport packets can be multiplexed with other transport packets carrying other content, such as another video elementary stream 125 or an audio elementary stream. The multiplexed transport packets form what is known as a transport stream. The transport stream is transmitted over a communication medium for decoding and displaying.

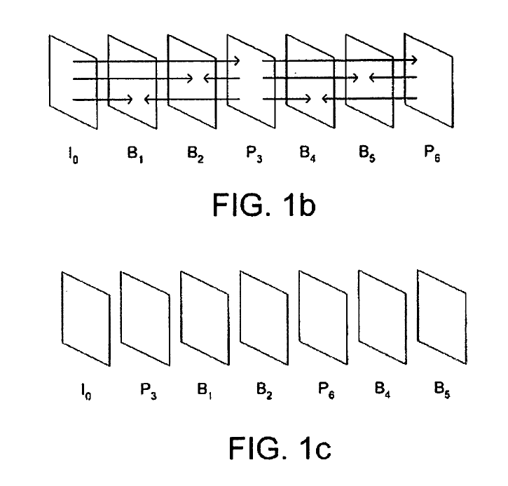

FIG. 2 illustrates a block diagram of an exemplary circuit for decoding the compressed video data, in accordance with an embodiment of the present invention. Data is received and stored in a presentation buffer 203 within a Synchronous Dynamic Random Access Memory (SDRAM) 201. The data can be received from either a communication channel or from a local memory, such as, for example, a hard disc or a DVD.

The data output from the presentation buffer 203 is then passed to a data transport processor 205. The data transport processor 205 demultiplexes the transport stream into packetized elementary stream constituents, and passes the audio transport stream to an audio decoder 215 and the video transport stream to a video transport processor 207 and then to a MPEG video decoder 209. The audio data is then sent to the output blocks, and the video is sent to a display engine 211.

The display engine 211 scales the video picture, renders the graphics, and constructs the complete display. Once the display is ready to be presented, it is passed to a video output encoder 213 where it is converted to analog video using an internal digital to analog converter (DAC). The digital audio is converted to analog in an audio digital to analog converter (DAC) 217.

The decoder 209 decodes at least one picture, I₀, B₁, B₂, P₃, B₄, B₅, P₆ . . . during each frame display period. Due to the presence of the B-pictures, B₁, B₂, the decoder 209 decodes the pictures, I₀, B₁, B₂, P₃, B₄, B₅, P₆ . . . . in an order that is different from the display order. The decoder 209 decodes each of the reference pictures prior to each picture that is predicted from the reference picture. For example, the decoder 209 decodes I₀, B₁, B₂, P₃, in the order, I₀, P₃, B₁, and B₂. After decoding I₀, the decoder 209 writes I₀ to a frame buffer 220 and decodes P₃. the frame buffer 220 can comprise a variety of memory systems, for example, a DRAM. The macroblocks of P₃ are encoded as prediction errors with respect to reference pixels in I₀. The reference pixels are indicated by motion vectors that are encoded with each macroblock of P₃. Accordingly, the video decoder 209 uses the motion vectors encoded with the macroblocks of P₃ to fetch the reference pixels. Similarly, the video decoder 209 uses motion vectors encoded with the macroblocks of B₁ and B₂ to locate reference pixels in I₀ and P₃.

To fetch the reference pixels from I₀, the video decoder 209 calculates the frame buffer 220 addresses storing the reference pixels, based on the motion vectors. A circuit known as a motion vector address computer calculates the frame buffer addresses. The video decoder 209 then fetches the pixels at the addresses calculated by the motion vector address computer in the frame buffer 220.

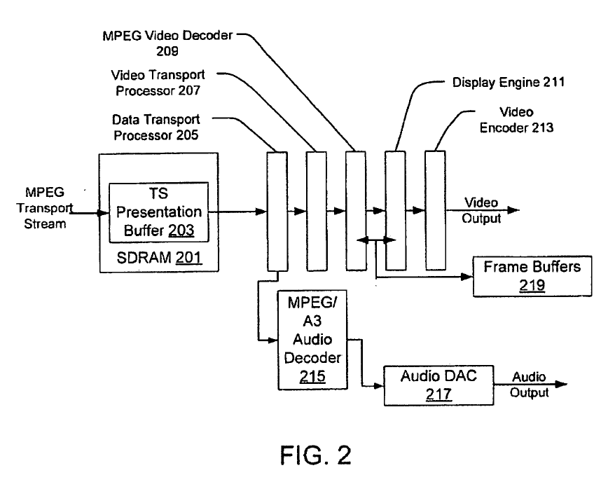

Referring now to FIG. 3, there is illustrated a block diagram of an exemplary video decoder 209 in accordance with an embodiment of the present invention. The video decoder 209 comprises a compressed data buffer 302, an extractor 304, a processor 306, a motion vector address computer 308, a video request manager 310, a motion compensator 312, a variable length decoder 314, an inverse quantizer 316, and an inverse discrete cosine transformation module 318.

The video decoder 209 fetches data from the compressed data buffer 302, via an extractor 304 that provides the fetched data to a processor 306. The video decoder 209 decodes at least one picture per frame display period on a macroblock by macroblock basis. At least a portion of the data forming the picture is encoded using variable length code symbols. Accordingly, the variable length coded symbols are provided to a variable length decoder 314. The portions of the data that can be encoded using variable length codes can include the parameters, such as picture type, prediction type, progressive frame, and the motion vectors, as well as the encoded pixel data (frequency coefficients). The parameters are provided to the processor 306, while the frequency coefficients are provided to the inverse quantizer 316. The inverse quantizer 316 inverse quantizes the frequency coefficients and the IDCT module 318 transforms the frequency coefficients to the pixel domain.

If the macroblock is from an I-picture, the pixel domain data represents the pixels of the macroblock. If the macroblock is from a P-picture, the pixel domain data represents the prediction error between the macroblock and reference pixels from one other frame. If the macroblock is from a B-picture, the pixel domain data represents the prediction error between the macroblock and reference pixels from two other frames.

Where the macroblock is from a P or B picture, the video decoder 209 fetches the reference pixels from the reference frame(s) 103. The reference frame(s) is stored in a frame buffer(s) 220. The processor 306 provides the motion vectors encoded with the macroblock 111 to the motion vector address computer 308. The motion vector address computer 308 uses the motion vectors to calculate the address of the reference pixels in the frame buffer 220.

When the motion vector address computer 308 calculates the addresses associated with the reference pixels, the video request manager 310 fetches the reference pixels at the addresses calculated by the motion vector address computer 308, via a direct memory access module and memory controller. The reference pixels are then provided to a pixel reconstructor 312. The pixel reconstructor 312 applies the prediction error from the macroblock 111 to the fetched reference pixels, resulting in the decoded macroblock 111. The video request manager 310 then writes the decoded macroblock 111 to the frame buffer 220, using the direct memory access module and the memory controller.

As noted above, in MPEG-2, each of the luma blocks in the macroblock that are horizontally adjacent are associated with the same motion vectors. However, in Advanced Video Coding (AVC), there are modes of operation where each of the luma blocks 113 in a macroblock 111 can be associated with their own set of motion vectors. Accordingly, more addresses are calculated by the motion vector address computer 308, and more reference pixel accesses are made by the video request manager 310.

The pixel reconstructor 312 is capable of operating using different data flows, depending on whether the pixel reconstructor 312 is decoding MPEG-2 or AVC encoded data. Where the pixel reconstructor 312 is decoding MPEG-2 encoded data, the pixel reconstructor 312 decodes blocks 113 from a macroblock 121 in horizontal pairs. However, where the pixel reconstructor 312 is decoding AVC encoded data, the pixel reconstructor 312 decodes the blocks 113 individually.

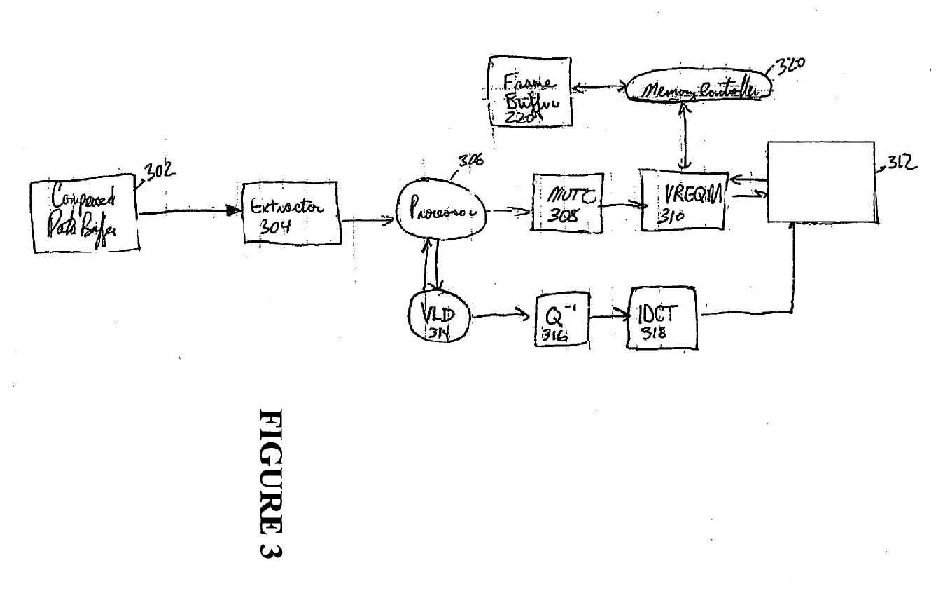

Referring now to FIG. 4, there is illustrated a block diagram describing the data flow of the pixel reconstructor 312 for MPEG-2 encoded video data in accordance with an embodiment of the present invention. The pixel reconstructor 312 comprises a macroblock input buffer 405, a multiplexer 410, a macroblock input register 415, a horizontal register 425, and a horizontal data path 430.

The macroblock input buffer 405 can store an 18×9 block of reference pixels. The pixel reconstructor 312 is capable of reconstructing two blocks of a macroblock at a time. The pixel reconstructor 312 generates one gword worth of pixels, 16 pixels across, y0 . . . y15, every three clock cycles.

During the first clock cycle, horizontal register 425 stores the reference pixels, R0 . . . R7, needed for pixels y0 . . . y7, while the horizontal data path 430 provides the reference pixels, R8 . . . R15 needed for pixels y8 . . . y15. The pixel reconstructor 312 applies offsets to the reference pixels R0 . . . R7, and the horizontal register 425 stores the reconstructed pixels y0 . . . y7. At the second clock cycle, the horizontal pixel register outputs reconstructed pixels y0 . . . y7 and receives the reference pixels R8 . . . R15 for pixels y8 . . . y15. The pixel reconstructor 312 applies offsets to the reference pixels R8 . . . R15, and the horizontal register 425 stores reconstructed pixels y8 . . . y15.

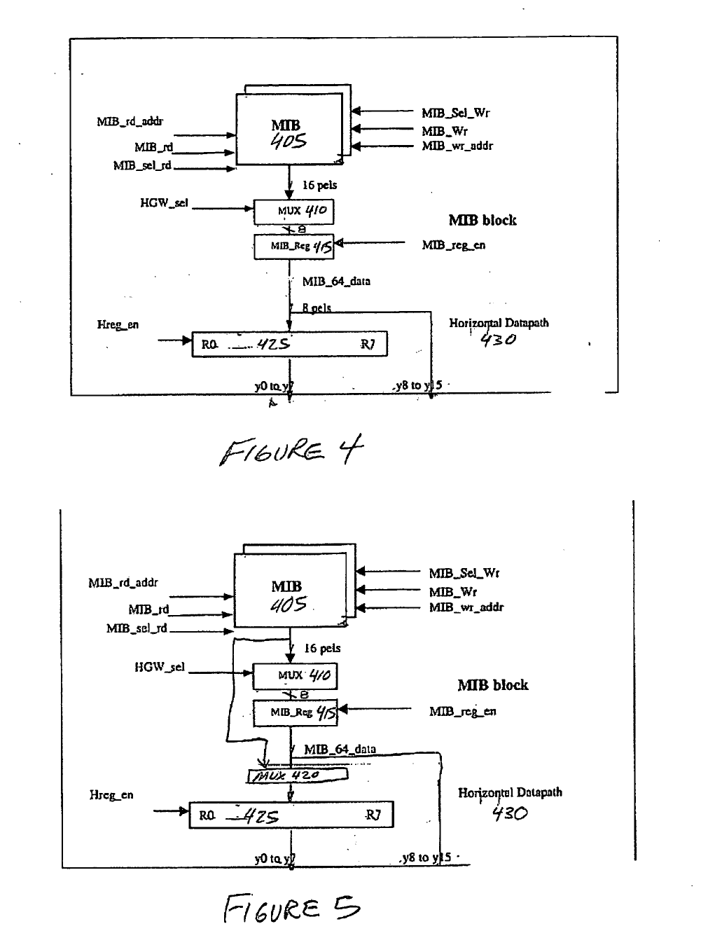

Referring now to FIG. 5, there is illustrated a block diagram describing the data flow of the pixel reconstructor 312 for AVC encoded video data in accordance with an embodiment of the present invention. The pixel reconstructor 312 comprises a macroblock input buffer 405, a multiplexer 410, a macroblock input register 415, a multiplexer 420, horizontal register 425, and a horizontal data path 430.

In the foregoing embodiment, the pixel reconstructor 312 generates a half gword every two clock cycles. The horizontal register 425 is reused to hold reference pixels.

The embodiments described herein may be implemented as a board level product, as a single chip, application specific integrated circuit (ASIC), or with varying levels of the decoder system integrated with other portions of the system as separate components. The degree of integration of the decoder system will primarily be determined by the speed and cost considerations. Because of the sophisticated nature of modern processor, it is possible to utilize a commercially available processor, which may be implemented external to an ASIC implementation. Alternatively, if the processor is available as an ASIC core or logic block, then the commercially available processor can be implemented as part of an ASIC device wherein certain functions can be implemented in firmware.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

1. A video decoder for decoding macroblocks, said video decoder comprising:
a processor for decoding a set of parameters, said set of parameters comprising motion vectors indicating reference pixels associated with the macroblock;
a motion vector address computer for calculating addresses associated with motion vectors;
a video request manager for fetching a block of reference pixels at the addresses calculated by the motion vector address computer; and
a pixel reconstructor for reconstructing pixels from the macroblocks, the pixel reconstructor operable to reconstruct pixels from macroblocks encoded in accordance with a plurality of standards.

2. The video decoder of claim 1, wherein the plurality of standards comprises MPEG-2 and AVC.

3. The video decoder of claim 1, wherein the pixel reconstructor comprises:
a macroblock input buffer for storing the reference pixels; and
a horizontal register for storing a portion of the reference pixels.

4. The video decoder of claim 1, wherein the pixel reconstructor comprises:
a horizontal data path for outputting another portion of the reference pixels.

5. A pixel reconstructor for decoding macroblocks, said pixel reconstructor comprising:
a macroblock input buffer;
a multiplexer connected to the macroblock input buffer;
a horizontal register connected to the multiplexer; and
a horizontal data path connected in parallel to the horizontal register.

6. A pixel reconstructor of claim 5, further comprising:
a macroblock input buffer register connected to the multiplexer.

7. A pixel reconstructor of claim 6, further comprising:
another multiplexer connected to the horizontal register.

8. The pixel reconstructor of claim 7, further comprising:
a bypass path connected to the macroblock input buffer and the another multiplexer, said bypass path bypassing the multiplexer and the multiplexer input buffer register.

9. The pixel reconstructor of claim 8 to reconstruct pixels from macroblocks encoded in accordance with a plurality of standards.

10. The pixel reconstructor of claim 9, wherein the plurality of standards comprises MPEG-2 and AVC.
